(19) United States
(12) Patent Application Publication
(10) Pub. No.: US 2025/0313005 A1
(43) Pub. Date: Oct. 9, 2025

(54) Drive Device for an Eccentric Bearing, and Corresponding Calender

(71) Applicants: Matthews International GmbH, Vreden (DE); Matthews International Corporation, Pittsburgh, PA (US)

(72) Inventors: Harald BARTSCH, Dorsten (DE); Hermann Bernhard WILMER, Vreden (DE)

(21) Appl. No.: 18/864,616

(22) PCT Filed: May 12, 2022
(86) PCT No.: PCT/DE2022/100357

§ 371 Date: Nov. 11, 2024

(51) Int. Cl. B41F 13/008; F16C 23/10; F16H 1/20

(52) U.S. Cl. CPC B41F 13/008; F16C 23/10; F16H 1/203; F16C 2324/16

(57) ABSTRACT

The invention relates to a drive device for an eccentric bearing for radially deflecting a roller mounted therein, the eccentric bearing comprising a bore which is oriented in an axial direction and intended for accommodating a roller journal of a roller, and the eccentric bearing comprising an outer eccentric bushing and an inner eccentric bushing which is partially inserted into the outer eccentric bushing and has the bore, such that the eccentric bushings have an axial overlap region, characterized in that at least one of the eccentric bushings has a free end outside the overlap region, which free end is coupled to a drive unit via which the at least one eccentric bushing is rotatable about the axial direction in order to adjust a radial axial deflection of the bore with respect to the other eccentric bushing. The invention also relates to a corresponding calender.

The invention relates to a drive device for an eccentric bearing for radially deflecting a roller mounted therein as well as a corresponding calender, wherein the eccentric bearing comprises a bore oriented in an axial direction for accommodating a roller journal of a roller, and wherein the eccentric bearing comprises an outer eccentric bushing and an inner eccentric bushing which is partially inserted into the outer eccentric bushing and has the bore, such that the eccentric bushings have an axial overlap region.

A printing press bearing is known from the prior art which has eccentric rings for axially displacing or obliquely positioning a cylinder mounted in the printing press bearing, which rings can each be pivoted against each other and/or around the cylinder. The adjustment of the eccentric rings in the solution disclosed in the prior art is carried out by means of pivotally mounted actuating elements in the form of pivot levers arranged on the front side on the outside of the bearing, which levers can be displaced in the tangential direction around the cylinder axis to set a desired eccentricity.

However, the device disclosed in the prior art has the disadvantage that it takes up a lot of space due to the frontal arrangement of the pivot levers extending away from the cylinder axis and their displacement both in the horizontal and vertical direction, particularly in the radial direction of the cylinder, and is not suitable for tight installation spaces.

It is therefore the object of the present invention to improve a drive device for an eccentric bearing in such a way that it has a compact design.

The invention is achieved by the features of the independent claims. Advantageous embodiments are described in the dependent claims.

Accordingly, it is provided that at least one of the eccentric bushings has a free end outside the overlap region, which free end is coupled to a drive unit, via which the at least one eccentric bushing can be rotated about the axial direction in order to adjust a radial axial deflection of the bore relative to the other eccentric bushing. Because at least one of the eccentric bushings has a free end, it is possible to avoid driving the corresponding eccentric bushing from the front, but to introduce the force into the eccentric bushing in a space-saving manner via a tangentially arranged drive unit.

It can be provided that the inner eccentric bushing is rotatably mounted in the outer eccentric bushing. Accordingly, a radial bearing can be arranged in the axial overlap region between the outer surface of the inner eccentric bushing and the inner surface of the outer eccentric bushing. Furthermore, it can be provided that a roller journal which can be accommodated in the bore can be rotatably mounted in the inner eccentric bushing. Accordingly, a further radial bearing can be arranged in the axial overlap region on the inner surface of the inner eccentric bushing. The eccentric bearing can be accommodated in a bore or bushing provided in a calender frame and can be rotatably mounted therein. Accordingly, a radial bearing can also be arranged in the overlap region between the outer eccentric bushing and the inner surface of the bore or bushing. Thus, the outer eccentric bushing can be rotated relative to the bore or bushing, the inner eccentric bushing relative to the outer eccentric bushing and the roller possibly accommodated in the inner eccentric bushing, can be rotated relative to the inner eccentric bushing.

The inner bore of the external eccentric bushing can be eccentric with respect to its outer diameter. The inner eccentric bushing can be accommodated in the inner bore of the outer eccentric bushing. Furthermore, the inner bore of the inner eccentric bushing can be eccentric with respect to the outer diameter of the inner eccentric bushing. The inner bore of the inner eccentric bushing can also be concentric to the outer diameter of the outer eccentric bushing in a starting position of both eccentric bushings. The inner and outer eccentric bushings are rotatable relative to one another or in the same direction, so that the eccentricity of the inner bore of the inner eccentric bushing is adjustable, wherein the direction and degree of eccentricity are variable. To this end, each of the eccentric bushings has a thick portion and a thin portion opposite to the thick portion. In the starting position described above, the thick portion of the outer eccentric bushing and the thin portion of the inner eccentric bushing can be proximate, and the thin portion of the outer eccentric bushing and the thick portion of the inner eccentric bushing can be proximate. When both eccentric bushings are rotated relative to one another by 180°, the greatest possible off-center deflection can thus be achieved. Furthermore, a linear straight deflection can be achieved by simultaneously rotating the inner and outer eccentric bushings in opposite directions. In addition, a change in the direction of the deflection can be achieved by simultaneously rotating the inner and outer eccentric bushings in the same direction of rotation.

Furthermore, it can be provided that both eccentric bushings have a free end on opposite sides of the overlap region, which are each coupled to a drive unit via which the eccentric bushings can be rotated independently of one another about the axial direction in order to adjust the radial axial deflection of the bore.

Furthermore, it can be provided that the drive unit has a transmission output, for example an external toothing, arranged at least in portions on the outer circumference of the free end and coupled to the free end. The transmission output can, for example, extend over half the circumference of the free end of the eccentric bushing so that it can be pivoted by 180°. The transmission output can thus surround the eccentric bushing along a semicircle. The free ends can essentially be designed as cylindrical hollow bodies.

Furthermore, the drive unit can have a drive element coupled to the transmission output, which is arranged perpendicular to the axial direction. The drive element can be driven rotationally or translationally. For example, the drive element can be formed by a rack. The drive element can in particular have a worm shaft that engages with the transmission output or the external toothing. The drive element, which is designed as a worm shaft, performs a rotary drive movement.

It can be provided that the drive units are spaced apart from each other in the axial direction. In particular, the drive elements can be spaced apart from one another in the axial direction. The distance can in particular correspond to the distance between the transmission outputs on the respective free ends. It can be provided that the drive elements are each accommodated in a housing surrounding them. The housings, like the drive elements, can extend perpendicular to the axial direction of the drive device. The housings can each have an interface to the bore or bushing in which the drive device is accommodated. In the region of the interfaces, the drive elements accommodated in the housings can engage with the gear outputs accommodated in the bore or bushing at the free ends of the eccentric bushings.

The eccentric bearing can be mounted in a bushing or a bore of a machine frame or in particular a calender frame, wherein the drive element is driven by a motor arranged outside the bushing or the bore. If two drive devices are provided on the eccentric bearing, the drive elements can be arranged on the same side or different sides of the central bore axis and aligned parallel to each other. It can be provided that one of the motors is coupled to one of the drive elements via a first side and the other of the motors is coupled to the other of the drive elements via the opposite side. For example, if the bore or roller is oriented horizontally, the drive elements may be arranged vertically and one of the motors may be coupled to the top of one drive element and the other motor may be coupled to the bottom of the other drive element.

Furthermore, it can be provided that an angular offset is provided between the drive element and the motor. The angular offset can, for example, be designed such that the motor is arranged perpendicular to the drive element. The angular offset can be realized by an angular gear coupling the drive element to the motor. The angular gear can be, for example, a bevel gear, a bevel planetary gear or a hypoid gear. The motor can in particular be a servo motor. This allows the angular position of the motor shaft as well as the rotation speed and acceleration to be controlled. The servo motor can have a sensor for determining the position.

Furthermore, it can be provided that the eccentric bushings each have an adjustment scale that can be read from the outside of the bushing. This can be used to check the actual position of the eccentric bushings. It can be provided that the adjustment scale of the one eccentric bushing points in the axial direction and the adjustment scale of the other eccentric bushing points in a radial direction and the adjustment scales can be read from there. For example, the scale of the eccentric bushing facing the outside of the roller can be designed so that it can be read from the front. Furthermore, the adjustment scale of the eccentric bushing directed towards the center of the roller can be designed such that it can be read from an upper or lower side of the bushing accommodating the drive device. The amounts of the desired axial deflection are converted using the angular function of the rotation of the eccentrics. The increment can be read in 0.2 mm steps from 0 mm up to a maximum value of 4 mm.

The invention further relates to a calender with at least two rollers arranged in parallel and mounted in a calender frame, between which a roller gap is formed, wherein the rollers each have a roller journal mounted in the calender frame at their opposite ends, wherein at least two adjacent roller journals have a drive device according to any one of the preceding claims. Because a drive device according to the invention is provided on each of two adjacent roller journals for driving the eccentric bearings, only a small installation space is available, in particular for the motors for driving the drive elements. Due to the advantageous introduction of force for adjusting the eccentric bushings made possible by the drive device according to the invention, it is possible to adjust the eccentric bushings in a space-saving manner.

Furthermore, it can be provided that in the calender all roller journals of the two rollers each have a drive device according to any one of claims 1 to 13.

In particular, it can be provided that the drive elements of the adjacent drive devices are aligned parallel to one another. For example, if the bore or roller axis is horizontally aligned, they can be oriented vertically. Both drive elements can be arranged either on the same side or on opposite sides of the bore or roller axis. For example, both drive elements can be arranged to the right or left of the roller axis or on different sides, i.e. right and left, of the roller axis.

The motors of the adjacent drive devices can be arranged so that they are either aligned parallel to the roller axes or point away from the adjacent drive device. For example, a first motor of a drive device can be arranged parallel to the roller axis and a second motor of the drive device can be arranged perpendicular to the roller axis and pointing away from the adjacent drive device. The motors of the adjacent drive device can be oriented accordingly.

It can be provided that a first support roller is arranged adjacent to a first of the rollers and a second support roller is arranged adjacent to a second of the rollers, which each rotate in opposite directions to the latter. The support rollers can each have a larger diameter than the rollers. The rollers can each have the same diameter and the support rollers can also have the same diameter. The rollers can each have a diameter of 200 mm. The support rollers can each have a diameter of 700 mm. The axes of the rollers and the support rollers can be oriented in one plane. The first roller and the first support roller can roll on each other and a roller gap can be formed between the second roller and the second support roller.

Further details of the invention are explained using the figures below. In the figures:

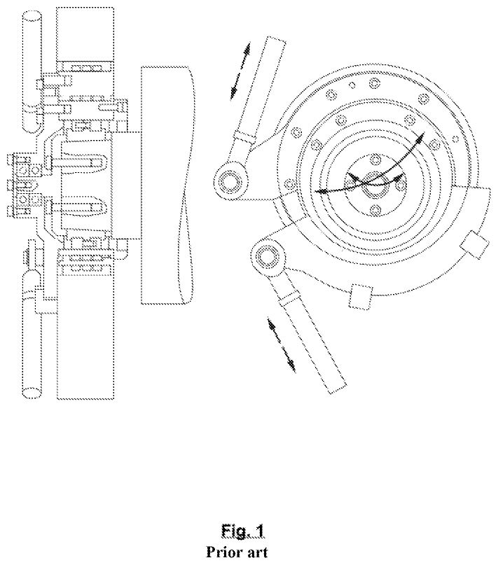

FIG. 1 shows an actuating mechanism known from the prior art for adjusting eccentric rings of a printing press bearing;

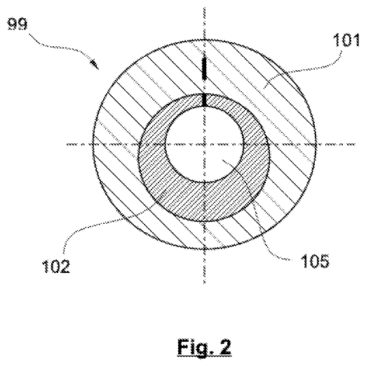

FIG. 2 shows a schematic front view of an eccentric bearing for radially deflecting a bearing journal;

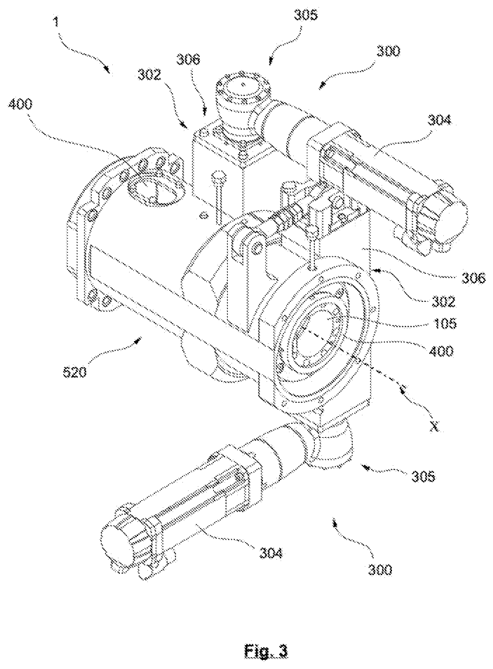

FIG. 3 shows a perspective view of an embodiment of the drive device according to the invention;

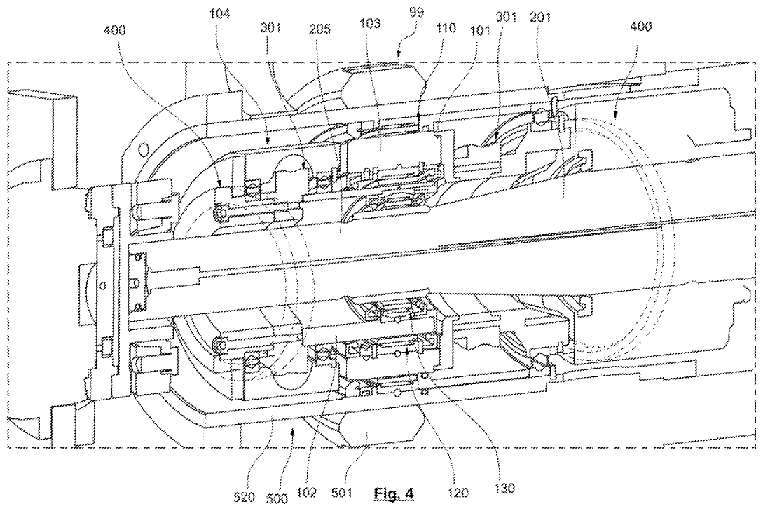

FIG. 4 shows a perspective sectional view of a roller journal mounted in an eccentric bearing;

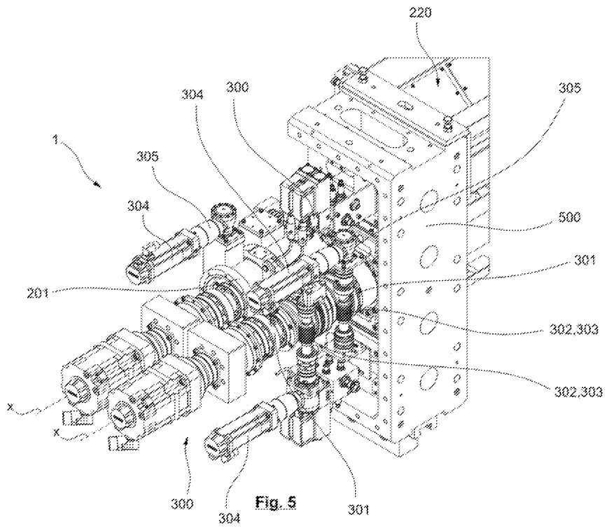

FIG. 5 shows a perspective front view of a roller calender provided with drive devices;

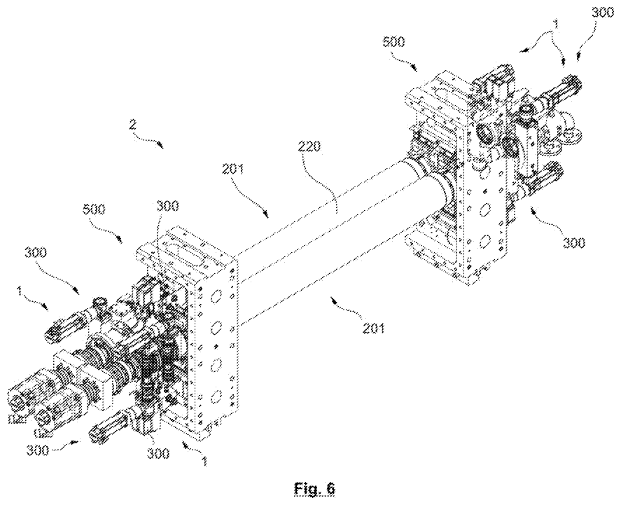

FIG. 6 shows a perspective overall view of a roller calender provided with drive devices; and

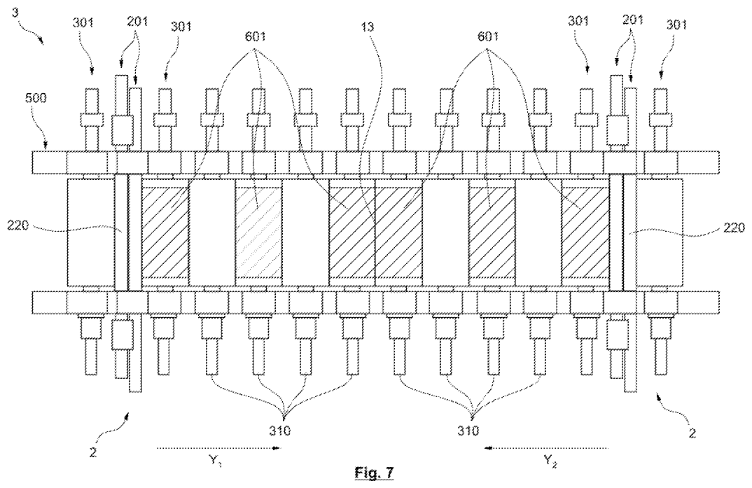

FIG. 7 shows a top view of a calender provided with drive devices for producing an electrode film from a powdery electrode precursor material.

The illustration shown in FIG. 1 shows a printing press bearing known from the prior art, which has eccentric rings for the axial displacement or oblique positioning of a printing cylinder mounted therein, which can each be pivoted against each other and/or about the cylinder axis. The eccentric rings have the same axial thickness and are arranged in alignment with each other so that the eccentric rings overlap each other over their entire thickness. As can be seen, the adjustment of the eccentric rings in the solution disclosed in the prior art is carried out by means of pivotally mounted levers arranged on the outside of the bearing, which levers can be displaced in the tangential direction around the cylinder in order to set the required eccentricity. However, the solution shown has the disadvantage that it takes up a lot of space due to the necessary length of the levers and their displacement both in the horizontal and vertical direction, especially in the radial direction of the cylinder, and is not suitable for tight installation spaces.

FIG. 2 shows an exemplary eccentric bearing 99, which is used to deflect a roller journal 205 in any direction orthogonal to the center axis of the respective roller 201, 202 and with an adjustable magnitude. The eccentric bearing 99 has an outer eccentric bushing 101, the inner bore of which is eccentric with respect to the outer diameter of the external eccentric bushing 101. The eccentric bearing 99 also has an inner eccentric bushing 102, the inner bore 105 of which is concentric to the outer diameter of the outer eccentric bushing 101 in a starting position. The inner and outer eccentric bushing 102, 101 are pivotable relative to one another or in the same direction, so that the eccentricity of the inner bore 105 of the inner eccentric bushing 102 is adjustable, wherein the direction and degree of deflection are variable. Each of the eccentric bushings 101, 102 has a thick portion and a thin portion opposite to the thick portion. In the starting position described above, the thick portion of the outer eccentric bushing 101 and the thin portion of the inner eccentric bushing 102 are proximate, and the thin portion of the outer eccentric bushing 101 and the thick portion of the inner eccentric bushing 102 are proximate. When both eccentric bushings 101, 102 are pivoted relative to one another by 180°, the greatest possible off-center deflection can be achieved.

FIG. 2 shows an embodiment of the drive device 1 according to the invention. In a bushing 520 that can be connected to a machine frame 500, an eccentric bearing 99 is accommodated, which has an inner and an outer eccentric bushing 101, 102, which are rotatable relative to one another about an X-axis, or are rotatable relative to the bushing 520 or relative to a roller journal 205 that can be accommodated in an inner bore 105 of the inner eccentric bushing 102. To drive the eccentric bushing facing the center of the roller, a first drive unit 300 is provided, which has a drive element 302 arranged perpendicular to the X-axis, and which is accommodated in a housing 306. The housing 306 has an interface with the bushing 520, via which the drive element 302 is coupled to a transmission output in the form of an external toothing 301, which is arranged on the outer circumference of a free end 104 of the eccentric bushing, wherein the drive element 302 is tangentially linked to the external toothing 301. A servo motor 304 driving the drive element 302 is coupled to the drive element 302 via an angular gear 305, wherein the motor 304 is arranged perpendicular to the drive element 302 and parallel to the X-axis above the bushing 520. To drive the eccentric bushing facing away from the roller center, a second drive unit 300 is provided, which is designed correspondingly to the first drive unit 300, wherein the drive element 302 accommodated in the housing 306 is coupled to the free end 104 of the eccentric bushing facing away from the roller center. The housings 306 and the drive elements 302 are arranged parallel to each other to the right of the X-axis. In contrast to the first drive unit 300, in the second drive unit 300 the motor 304 is arranged on the underside of the bushing 520, also perpendicular to the drive element 302, but not parallel to the X-axis, but rather perpendicular to it, crossing the bushing 520. In order to read the setting of the eccentric bushing facing the center of the roller, the bushing 520 has a viewing window on its upper side through which the adjustment scale 400 provided on the free end 104 can be read. In order to read the setting of the eccentric bushing facing away from the center of the roller, the front side of the free end 104 of the eccentric bushing has a scaling ring with a further adjustment scale 400 so that it can be read from the front.

FIG. 4 shows a sectional view through a roller 201 and an eccentric bearing 99 mounted on the roller journal 205 of the roller 201. The roller 201 is mounted in a machine frame 500, which has a bushing 520 in which the roller journal 205 together with the eccentric bearing 99 is accommodated. The eccentric bearing 99 essentially comprises an inner eccentric bushing 102 and an outer eccentric bushing 101, wherein the roller journal 205 is accommodated in a bore 105 of the inner eccentric bushing 102. The inner eccentric bushing 102 is inserted in portions into the outer eccentric bushing 101 so that they have an axial overlap region 103. The outer eccentric bushing 101 is mounted in an axially rotatable manner in the cylinder bushing via a first radial bearing 110. The inner eccentric bushing 102 is mounted in the outer eccentric bushing 101 via a second axially rotatable radial bearing 120. The roller journal 205 is in turn mounted in an axially rotatable manner in the inner eccentric bushing 130 via a third radial bearing 130. With the orientation shown, the eccentric bearing 99 is in its starting position, in which the thick portion of the outer eccentric bushing 101 is proximate to the thin portion of the inner eccentric bushing 102 and the thin portion of the outer eccentric bushing 101 is proximate to the thick portion of the inner eccentric bushing 102 so that the roller journal 205 is centered and not deflected. The eccentric bushings 101 and 102 are adjustable independently of each other by means of separate drive units 300. For this purpose, the eccentric bushings 101, 102 each have free ends 104 opposite and extending away from the overlap region 103, which each have a transmission output in the form of an external toothing 301, via which the eccentric bushings 101, 102 can be adjusted independently of one another. On the front side, the inner eccentric bushing 102 facing away from the roller center has an adjustment scale 400 that can be read from the front side. On the rear side, the outer eccentric bushing 101 facing the center of the roller has an adjustment scale 400 that can be read on the circumference.

FIG. 5 shows a perspective front view of a calender 2 with two rollers 201 mounted horizontally and parallel in a machine frame 500, which rollers form a roller gap 220 and are therefore arranged very close to one another. A drive device 1 with two drive units 300 each is respectively mounted on the roller journals 205 protruding from the machine frame. As shown, the drive elements 302 each have a worm shaft 303 which engages with the respective external gears 301. The drive elements 302 are all respectively arranged vertically on the sides of the rollers 201 facing away from the roller gap 220, wherein one motor 304 of each drive device 1 is respectively arranged above the respective roller 201 and one motor 304 of each drive device 1 is arranged below the respective roller 201. At the same time, all motors are aligned perpendicular to the drive elements 302 and parallel to the roller axes X.

FIG. 6 shows an overall view of the calender 2 shown in FIG. 5. This shows the essentially mirror-image mounting of the roller journals 205 provided at opposite ends of the rollers 201 in the machine frame 500, wherein a drive device 1 each with one eccentric bearing 99 and two drive units 300 is mounted on each roller journal 205. Clearly visible is the roller gap 220 of a few millimeters formed between the rollers 201, due to which the rollers 201 require a very compact design of connecting elements such as the drive units 300 on the front side. All of the motors 304 are mounted on the side of the rollers 201 facing away from the roller gap 220, with one motor 304 respectively mounted on the top and one motor 304 mounted on the bottom of the roller 201 and mounted parallel to the roller axes X.

FIG. 7 shows a top view of a multi-roller calender 3, which shows the arrangement of the rollers 201 in relation to the support rollers 210 in an integrated roller system according to an embodiment. The multi-roller calender 2 is used to produce a separator film (not shown) coated on both sides using electrode films 601, 602. The arrangement has two calender arrangements 2 positioned frontally side by side, which have opposite main conveying directions Y1, Y2. The calender arrangements 2 each have eight rollers 201, 210, 310 mounted in a machine frame 500. On the input side, the arrangement has two rollers 201 supported laterally by support rollers 210, which are used as a powder mill for producing the electrode films 601, 602 from a powdered electrode precursor material. The support rollers are followed by respective four conveyor rollers 310, which bring the electrode film to the desired width and thickness and homogenize it. The input-side end roller 210 is designed as a support roller 210 that rolls directly on the first roller 201. The output-side conveyor rollers 310 form a common end roller gap 13 in which the electrode films 601, 602 are applied to the separator film.

The features of the invention disclosed in the above description, in the figures and in the claims can be essential for the implementation of the invention both individually and in any combination.

### LIST OF REFERENCE NUMERALS

1 drive device
2 calender
13 end roller gap
99 eccentric bearing
100 pre-tensioning device
101 outer eccentric bushing
102 inner eccentric bushing
103 axial overlap region
104 free end
105 bore of the inner eccentric bushing
110 first radial bearing
120 second radial bearing
130 third radial bearing
201 roller
205 roller journal
210 support roller
220 roller gap
300 drive unit
301 external toothing
302 drive element
303 worm shaft
304 motor
305 angular gear
310 conveyor rollers
400 adjustment scale
500 calender frame
501 bearing
520 bore/bushing
601 first electrode film
602 second electrode film
X axial direction
Y1 conveying direction of the first electrode film
Y2 conveying direction of the second electrode film

1. A drive device for an eccentric bearing for radially deflecting a roller mounted therein, wherein the eccentric bearing comprises a bore oriented in an axial direction (X) for accommodating a roller journal of a roller, and wherein the eccentric bearing comprises an outer eccentric bushing and an inner eccentric bushing which is partially inserted into the outer eccentric bushing and has the bore, such that the eccentric bushings have an axial overlap region, characterized in that at least one of the eccentric bushings has a free end outside the axial overlap region, which free end is coupled to a drive unit, via which the at least one eccentric bushing is rotatable about the axial direction (X) for adjusting a radial axial deflection of the bore relative to the other eccentric bushing.

2. The drive device according to claim 1, in which both eccentric bushings have a free end on opposite sides of the axial overlap region, which free ends are each coupled to a drive unit via which the eccentric bushings can be rotated independently of one another about the axial direction (X) in order to adjust the radial axis deflection of the bore.

3. The drive device according to claim 1, wherein the drive unit has a transmission output, for example an external toothing, arranged at least in portions on the outer circumference of the free end and coupled to the free end.

4. The drive device according to claim 3, wherein the drive unit has a drive element coupled to the transmission output, which is arranged perpendicular to the axial direction (X).

5. The drive device according to claim 4, wherein the drive element has a worm shaft engaging with the transmission output or external toothing.

6. The drive device according to claim 2, wherein the drive units are spaced apart from one another in the axial direction.

7. The drive device according to claim 4, wherein the eccentric bearing is mounted in a bushing of a machine frame, wherein the drive element is driven via a motor arranged outside the bushing.

8. The drive device according to claim 4, wherein an angular offset is provided between the drive element and the motor.

9. The drive device according to claim 8, wherein the angular offset is designed such that the motor is arranged perpendicular to the drive element.

10. The drive device according to claim 8, wherein the angular offset is provided by an angular gear coupling the drive element to the motor.

11. The drive device according to claim 7, wherein the motor is a servo motor.

12. The drive device according to claim 1, wherein the eccentric bushings each have an adjustment scale that can be read from the outside of the bushing.

13. The drive device according to claim 11, wherein the adjustment scale of the one eccentric bushing points in the axial direction and the setting scale of the other eccentric bushing points in a radial direction (Y) and the setting scales can each be read from there.

14. A calender with at least two rollers arranged in parallel and mounted in a calender frame, between which a roller gap is formed, wherein the rollers each have a roller journal mounted in the calender frame at their opposite ends, wherein at least two adjacent roller journals have a drive device according to claim 1.

15. The calender according to claim 14, wherein all roller journals of the two rollers each have a drive device according to claim 1.

16. The calender according to claim 14, wherein the drive elements of the adjacent drive devices are oriented parallel to each other.

17. The calender according to claim 14, wherein the motors of the adjacent drive devices are arranged such that they are either oriented parallel to the roller axes or point away from the respective adjacent drive device.

18. The calender according to claim 14, wherein a first support roller is arranged adjacent to a first of the rollers and a second support roller is arranged adjacent to a second of the rollers, which each rotate in the opposite direction to the latter.

19. The calender according to claim 17, wherein the support rollers each have a larger diameter than the rollers.

20. The calender according to claim 17, wherein the axes of the rollers and of the support rollers are aligned in a plane with one another.

21. The calender according to claim 14, wherein the first roller and the first support roller roll on each other and a roller gap is formed between the second roller and the second support roller.
